(19) United States
(12) Patent Application Publication
(10) Pub. No.: US 2025/0138224 A1
(43) Pub. Date: May 1, 2025

(54) METHOD OF MACHINING MOLD FOR MICROLENS ARRAY

(71) Applicant: NALUX CO., LTD., Osaka (JP)

(72) Inventors: Toshiki HAMATANI, Osaka (JP); Yukinobu NISHIO, Osaka (JP); Tomohito KUWAGAITO, Osaka (JP)

(73) Assignee: NALUX CO., LTD., Osaka (JP)

(21) Appl. No.: 19/010,569

(22) Filed: Jan. 6, 2025

Related U.S. Application Data
(63) Continuation of application No. PCT/JP2023/027546, filed on Jul. 27, 2023.
(60) Provisional application No. 63/396,757, filed on Aug. 10, 2022.

(51) Int. Cl. G02B 3/00

(52) U.S. Cl. CPC G02B 3/0025

(57) ABSTRACT

A method of machining a mold for a microlens array, wherein for a surface of the mold corresponding to a microlens surface, an xyz coordinate system is defined such that a z-axis is parallel to the central axis of the surface, an angle φ is defined as an angle around a straight line passing through a point on the rotation axis and parallel to the z-axis, of a plane containing the rotation axis of a cutting tool and the straight line, in machining of a surface of the mold, the angle φ is kept constant and in machining of the surfaces of the mold, values of the angle φ for the surfaces of the mold are distributed so as to make variance of the values of the angle φ greater than a predetermined value.

### CROSS REFERENCE TO RELATED APPLICATION

This is a Continuation of International Patent Application No. PCT/JP2023/027546 filed Jul. 27, 2023, which designates the U.S., and which claims priority from U.S. Provisional Patent Application No. 63/396,757, filed Aug. 10, 2022. The contents of these applications are hereby incorporated by reference.

### TECHNICAL FIELD

The present invention relates to a method of machining a mold for a microlens array.

### BACKGROUND ART

When a mold for a microlens array is machined by a machine such as a multi-axis machine, plural surfaces of the mold corresponding to plural microlens surfaces are machined one after another (Patent document 1, for example). When a surface of a mold is machined by a cutting tool that rotates around the central axis such as a ball end mill, a relatively great form error tends to appear particularly at a position that is machined by a portion around the central axis of the cutting tool due to disagreement between the central axis and the rotation axis of the cutting tool caused by an error generated in process of production of the cutting tool and an error caused by attachment of the cutting tool or the like. For this reason, in a conventional method of machining a mold, relatively great form error tends to appear at a similar position in each of plural surfaces of the mold that correspond to plural microlens surfaces. Accordingly, form error in each of plural surfaces of a microlens array produced using the mold is relatively great at a specific position. Consequently, when the microlens array is used as an optical element for increasing divergence of a light beam by refraction, for example, on a surface illuminated using the microlens array, variance in illuminance caused by form error at the specific position in each of microlens surfaces of the microlens array is accumulated and variance in illuminance at a specific position on the illuminated surface, the specific position corresponding to the specific position in each of microlens surfaces, tends to become relatively great.

For this reason, conventional methods of machining a mold for a microlens array cannot sufficiently fill the need of finer microlenses and upsized microlens arrays. In other words, a method of machining a mold for a high-performance large microlens array with great number of microlenses has not been developed. Accordingly, there is a need for a method of machining a mold for a high-performance large microlens array with great number of microlenses.

### PATENT DOCUMENT

Patent document 1: JP2018043444A

The object of the present invention is to provide a method of machining a mold for a high-performance large microlens array with great number of microlenses.

### SUMMARY OF THE INVENTION

A method of machining a mold for a microlens array according to a first aspect of the present invention is used for a mold for a microlens array provided with plural microlenses that have optical axes in the same direction and that are identically shaped using a cutting tool provided with a cutting blade that rotates around a rotation axis. For a surface of the mold corresponding to a microlens surface, an xyz orthogonal coordinate system is defined such that a z-axis is in the direction of the central axis of the surface of the mold, the central axis corresponding to the optical axis of the microlens, an angle θ is defined as an angle formed by the rotation axis of the cutting tool and a straight line passing through a point on the rotation axis and parallel to the z-axis, an angle ϕ is defined as an angle around the straight line of a plane containing the rotation axis of the cutting tool and the straight line and xyz orthogonal coordinate systems of plural surfaces of the mold corresponding to plural microlens surfaces are defined such that x-axes of the surfaces are parallel to one another and y-axes of the surfaces are parallel to one another. In machining of a surface of the mold, the angle ϕ is kept constant and when the angle θ is changed, the angle θ is changed such that a side of the cutting tool is not brought in contact with the surface. In machining of the plural surfaces of the mold, values of the angle ϕ for the plural surfaces of the mold are distributed so as to make variance of the values of the angle ϕ greater than a predetermined value such that variance in illuminance on a surface illuminated using a microlens array produced using the mold can be sufficiently reduced.

According to the method of machining a mold for a microlens array according to the present aspect, variance in illuminance on a surface illuminated using the microlens array, due to form error in the plural microlens surfaces can be reduced by distributing the values of the angle ϕ for the plural surfaces of the mold so as to make variance of the values of the angle ϕ greater than a predetermined value. The above-described form error in the plural microlens surfaces is caused by form error in shape of the cutting tool. Accordingly, a mold for a high-performance large microlens array with great number of microlenses can be machined according to the method of the present aspect.

In the method of machining a mold for a microlens array according to a first embodiment of the first aspect of the present invention, a maximum value of the angle θ is determined for each surface of the mold.

In the method of machining a mold for a microlens array according to a second embodiment of the first aspect of the present invention, in surfaces of the mold corresponding to 50 percent or more of all the microlens surfaces, a maximum value of the angle θ is 3 degrees or greater.

In surfaces of the mold corresponding to 50 percent or more of all the microlens surfaces, a maximum value of the angle θ should preferably be 3 degrees or greater in order to make positions in the surfaces of the mold at which prominent for error appears sufficiently vary from one surface to another.

In the method of machining a mold for a microlens array according to a third embodiment of the first aspect of the present invention, in machining of a surface of the mold, the angle θ is adjusted in an area where a distance between a cutting point of the cutting tool and the central axis of the surface is greater than a predetermined value and the angle θ is kept at a constant value in an area where a distance between the cutting point of the cutting tool and the central axis of the surface is equal to or smaller than the predetermined value.

According to the method of machining a mold for a microlens array according to the present embodiment, the angle θ can be adjusted such that a value of the angle θ is small enough at the periphery of the surface to avoid contact of a side of the cutting tool with the surface and the angle θ can be kept at a constant value in an area near the central axis of the surface. The predetermined value of a distance between the cutting point of the cutting tool and the central axis of the surface is, for example, 30 percent of the distance between the central axis and the periphery of the surface.

In the method of machining a mold for a microlens array according to a fourth embodiment of the first aspect of the present invention, in machining of a surface of the mold, when the angle θ is changed, a value of angular acceleration of the angle θ is determined such that a working accuracy of positioning of the cutting tool in all moving directions is equal to or less than a predetermined value.

According to the method of machining a mold for a microlens array according to the present embodiment, a high-accuracy machining of a surface of a microlens can be realized when the angle θ is changed during a period of machining of the surface.

In the method of machining a mold for a microlens array according to a fifth embodiment of the first aspect of the present invention, in machining of a surface of the mold, a tool path is spiral around the central axis of the surface.

In the method of machining a mold for a microlens array according to a sixth embodiment of the first aspect of the present invention, in machining of the plural surfaces of the mold corresponding to the plural microlens surfaces, the plural surfaces of the mold are divided into one or plural groups and in each group values of the angle ϕ are uniformly distributed or set at regular intervals between 0 and 360 degrees.

According to the method of machining a mold for a microlens array according to the present embodiment, variance of values of the angle ϕ can be easily increased and therefore variance in illuminance on a surface illuminated using the microlens array, due to form error in the plural microlens surfaces can be reduced.

In the method of machining a mold for a microlens array according to a seventh embodiment of the first aspect of the present invention, a 5-axis machine is used for machining, each x-axis, each y-axis and each z-axis are made to correspond to three linear-motion axes of the 5-axis machine and the angle θ and the angle ϕ are made to correspond to angles around two rotation axes of the 5-axis machine.

According to the method of machining a mold for a microlens array according to the present embodiment, a microlens array can be easily machined by the 5-axis machine.

In the method of machining a mold for a microlens array according to a eighth embodiment of the first aspect of the present invention, in machining of a surface of the mold, the angle θ is made to increase with decrease in distance between a cutting point of the cutting tool and the central axis of the surface.

In the method of machining a mold for a microlens array according to the present embodiment, a value of the angle θ is made small enough at the periphery of the surface to avoid contact of a side of the cutting tool with the surface and a value of the angle θ is made great enough in an area near the central axis of the surface to distribute values of the angle ϕ for the plural surfaces of the mold so as to make variance of the values of the angle ϕ greater than a predetermined value so that variance in illuminance on a surface illuminated using the microlens array, due to form error in the plural microlens surfaces can be reduced.

In the method of machining a mold for a microlens array according to a ninth embodiment of the first aspect of the present invention, in machining of a surface of the mold, the angle θ is changed according to a shape of the surface such that a side of the cutting tool is not brought in contact with the surface.

According to the method of machining a mold for a microlens array according to the present embodiment, contact between a side of the cutting tool and the surface of the mold can be avoided even when a shape of the surface in a cross section containing the central axis of the surface is complicated.

A method of producing a microlens array according to a second aspect of the present invention uses a mold hat has been machined according to any one of the methods described above.

According to the method of producing a microlens array according to the present aspect, a high-performance large microlens array with great number of microlenses can be produced.

### BRIEF DESCRIPTION OF DRAWINGS

FIG. 1 shows a 5-axis machine as an example of a machine used for a machining method according to the present invention;

FIG. 2 shows the cutting tool;

FIG. 3 shows an example of a tool path S of the cutting tool when a surface 210 of a mold, the surface corresponding to a lens surface, is machined by the 5-axis machine;

FIG. 4 shows a cross section containing the rotation axis of the cutting tool;

FIG. 5 is an enlarged drawing of the portion in the rectangle consisting of dashed lines in FIG. 4;

FIG. 6 shows a cross section containing the rotation axis of the cutting tool and the central axis of the surface;

FIG. 7 shows a cross section of a cutting tool, the cross section containing the central axis AX′ of the cutting tool and the rotation axis AX of the cutting tool, when the central axis AX′ of the cutting tool and the rotation axis AX of the cutting tool do not coincide with each other due to an error generated in process of production of the cutting tool;

FIG. 8 shows a cross section of a cutting tool, the cross section containing the central axis AX′ of the cutting tool and the rotation axis AX of the cutting tool, when the central axis AX′ of the cutting tool and the rotation axis AX of the cutting tool do not coincide with each other due to an error caused by attachment of the cutting tool;

FIG. 9 is a diagram showing form error of a surface of a mold that is a work piece, the surface corresponding to a lens surface;

FIG. 10 illustrates an inclination of the cutting tool;

FIG. 11 shows a positional relationship between a cutting tool and a tool path when an angle (acute angle) formed by the z-axis of the cutting tool and the rotation axis of the cutting tool is θ;

FIG. 12 is a drawing used to describe how to determine a maximum value of an angle (acute angle) θ formed by the z-axis of the cutting tool and the rotation axis of the cutting tool;

FIG. 13 illustrates an angle ϕ (acute angle) formed by the y-axis of the cutting tool and a plane containing the z-axis of the cutting tool and the rotation axis of the cutting tool;

FIG. 14A is a drawing used to describe a machining method according to an embodiment of the present invention;

FIG. 14B is a drawing used to describe a machining method according to another embodiment of the present invention;

FIG. 15 is a diagram showing form error of a surface generated in a conventional machining method in which the angle ϕ is kept constant and the angle θ is kept at 0;

FIG. 16 is a diagram showing form error of a surface generated in a machining method according to the present invention, in which the angle θ is made to increase with decrease in distance between the cutting point and the central axis of the surface;

FIG. 17 shows actual form error generated on a surface that has been cut according to a machining method described using FIG. 15;

FIG. 18 shows actual form error generated on a surface that has been cut according to a machining method described using FIG. 16;

FIG. 19 shows form error of a surface of a mold in a cross section cut by an x-z plane;

FIG. 20A shows an illuminance distribution on a flat surface illuminated through a microlens array produced using a mold without form error;

FIG. 20B shows a cross section cut by an x-z plane of the illuminance distribution shown in 20A;

FIG. 21A shows an illuminance distribution on a flat surface illuminated through a microlens array produced using a mold with the form error shown in FIG. 19;

FIG. 21B shows a cross section cut by an x-z plane of the illuminance distribution shown in 21A;

FIG. 22A shows an example of an averaged illuminance distribution;

FIG. 22B shows a section cut by an x-z plane of the illuminance distribution shown in 22A;

FIG. 23A shows another example of an averaged illuminance distribution;

FIG. 23B shows a cross section cut by an x-z plane of the illuminance distribution shown in 23A;

FIG. 24A shows another example of an averaged illuminance distribution;

FIG. 24B shows a cross section cut by an x-z plane of the illuminance distribution shown in 24A;

FIG. 25 shows an actual form error of a surface of a mold, the surface corresponding to a microlens surface, produced by the conventional machining method described using FIG. 15;

FIG. 26 shows an actual form error of another surface of a mold, the surface corresponding to another microlens surface, produced by the conventional machining method described using FIG. 15;

FIG. 27 shows an actual form error of a surface of a mold, the surface corresponding to a microlens surface, produced by the machining method according to the present invention, the method having been described using FIG. 16.

FIG. 28 shows an actual form error of another surface of a mold, the surface corresponding to another microlens surface, produced by the machining method according to the present invention, the method having been described using FIG. 16;

FIG. 29A shows an illuminance distribution on a flat surface illuminated through a microlens array produced by the machining method described using FIG. 15;

FIG. 29B shows a cross section cut by an x-z plane of the illuminance distribution shown in 29A;

FIG. 30A shows an illuminance distribution on a flat surface illuminated through a microlens array produced by the machining method described using FIG. 16; and

FIG. 30B shows a cross section cut by an x-z plane of the illuminance distribution shown in 30A.

### DESCRIPTION OF EMBODIMENTS

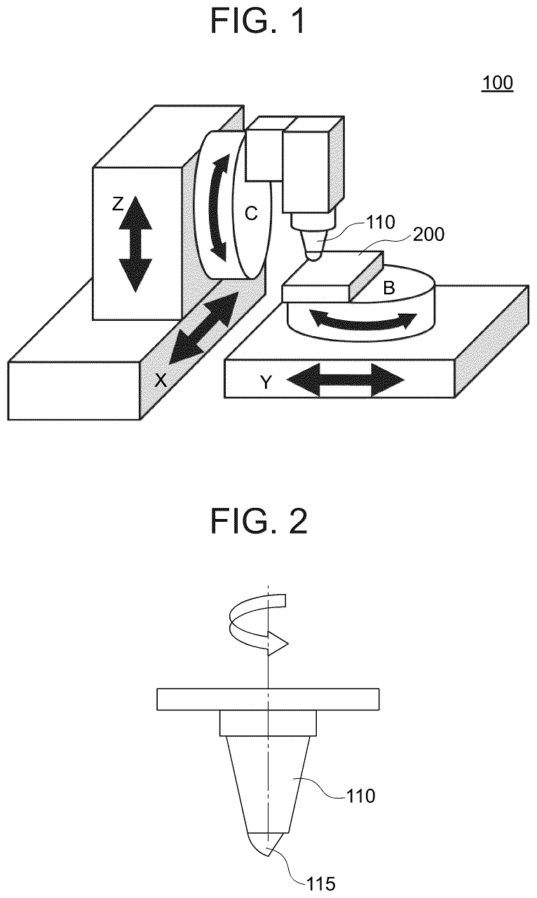

FIG. 1 shows a 5-axis machine 100 as an example of a machine used for a machining method according to the present invention. The 5-axis machine 100 is provided with three linear-motion axes (X, Y, Z) and two rotation axes (B, C). A work piece 200 is cut by a cutting tool 110. The cutting tool 110 is a ball end mill, for example.

FIG. 2 shows the cutting tool 110. The cutting tool 110 is provided with a cutting blade 115 and rotates around its rotation axis to cut the work piece 200. The contour of the cutting blade 115 in a cross section containing the rotation axis of the cutting tool 110 is of a circular arc.

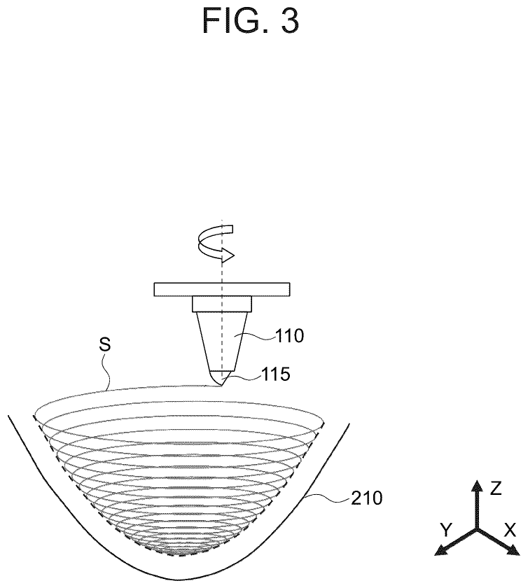

FIG. 3 shows an example of a tool path S of the cutting tool 110 when a surface 210 of a mold, the surface corresponding to a lens surface, is machined by the 5-axis machine 100. The tool path S is a path of a cutting point of the cutting tool 110. The lens surface and the surface 210 can be spherical, aspherical, of a free-form surface or the like. The tool path S is spiral around the central axis of the surface 210 of the mold as shown in FIG. 3, for example, and the cutting point initially located at the periphery of the surface 210 approaches the central axis along the tool path S. In general, machining should preferably be carried out along a tool path on the surface 210, which is continuous and does not intersect with itself. A position of the cutting point of the cutting tool 110 is controlled by the three linear-motion axes (X, Y, Z) of the 5-axis machine 100.

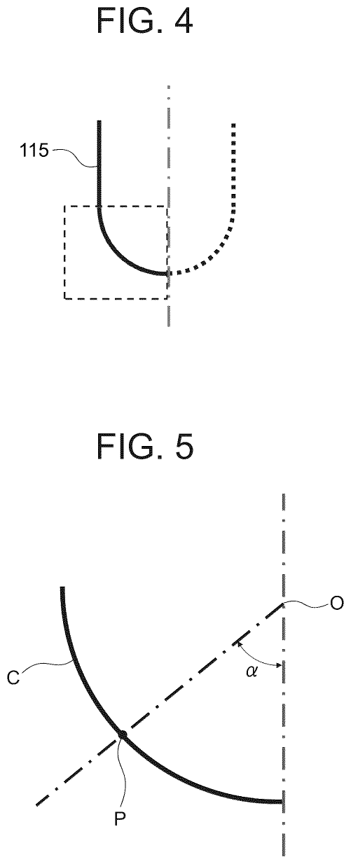

FIG. 4 shows a cross section containing the rotation axis of the cutting tool 110.

FIG. 5 is an enlarged drawing of the portion in the rectangle consisting of dashed lines in FIG. 4. In the cross section of FIG. 5 a designed circular arc of the contour of the cutting blade 115 is represented by C and the center of the circular arc C is represented by O. The center O is located on the rotation axis. In FIG. 5, a position of a point P on the cutting blade 115 is represented by a that is an angle (acute angle) formed by the rotation axis and the straight line connecting the point O and the point P.

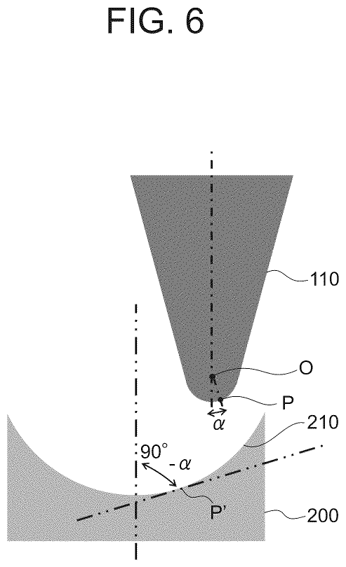

FIG. 6 shows a cross section containing the rotation axis of the cutting tool 110 and the central axis of the surface 210. When machining is carried out while the rotation axis is kept parallel to the central axis of the surface 210 as shown in FIG. 6, an angle formed by the central axis of the surface 210 and a straight line corresponding to a tangential plane of the surface 210 on a point P′ that is to be cut by the point P on the cutting tool 110 is (90-α) degrees. Thus, a point on the surface 210 that is to be cut by a point on the cutting tool 110 is determined by angle α.

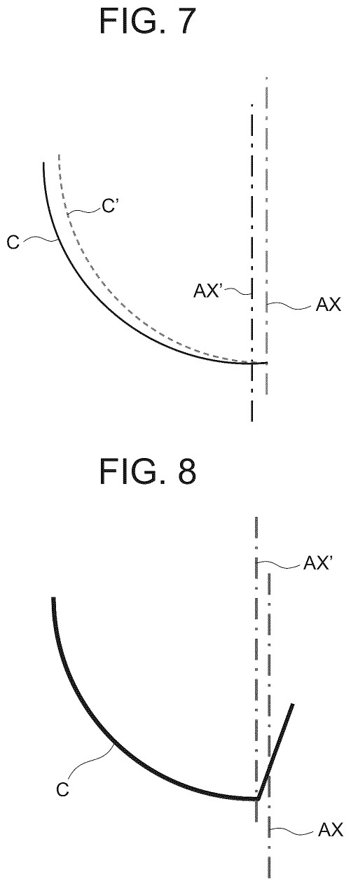

FIG. 7 shows a cross section of a cutting tool, the cross section containing the central axis AX′ of the cutting tool and the rotation axis AX of the cutting tool, when the central axis AX′ of the cutting tool and the rotation axis AX of the cutting tool do not coincide with each other due to an error generated in process of production of the cutting tool. In FIG. 7, a circular arc that shows an ideal cutting blade of the cutting tool is represented by C′. The central axis of the ideal cutting blade of the cutting tool coincides with the rotation axis AX. On the other hand, a circular arc that shows a cutting blade of the cutting tool when the central axis AX′ of the cutting tool and the rotation axis AX of the cutting tool 110 do not coincide with each other due to an error generated in process of production of the cutting tool is represented by C. In this case, a surface of the cutting blade of the cutting tool is substantially flat around the rotation axis of the cutting tool.

FIG. 8 shows a cross section of a cutting tool, the cross section containing the central axis AX′ of the cutting tool and the rotation axis AX of the cutting tool, when the central axis AX′ of the cutting tool and the rotation axis AX of the cutting tool do not coincide with each other due to an error caused by attachment of the cutting tool.

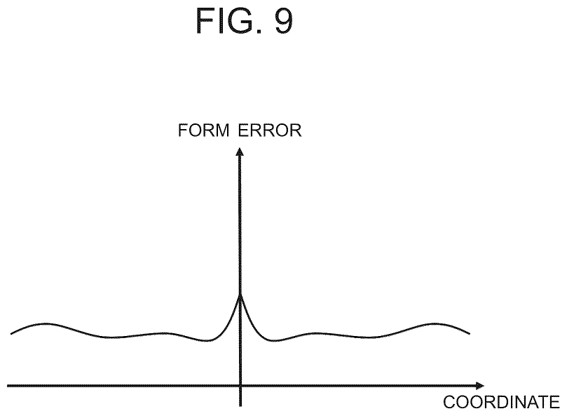

FIG. 9 is a diagram showing form error of a surface 210 of a mold that is a work piece 200, the surface corresponding to a lens surface. The horizontal axis of FIG. 9 indicates coordinate in the direction of a straight line orthogonal to the central axis of the surface 210 and the vertical axis of FIG. 9 indicates form error. When machining is carried out in the state shown in FIG. 6, form error generated due to an error generated in process of production of the cutting tool as illustrated by FIG. 7 and an error caused by attachment of the cutting tool as illustrated by FIG. 8, tends to reach a maximum value in an area around the central axis of the surface 210, the area being cut by the position of α=0 of the cutting blade of the cutting tool.

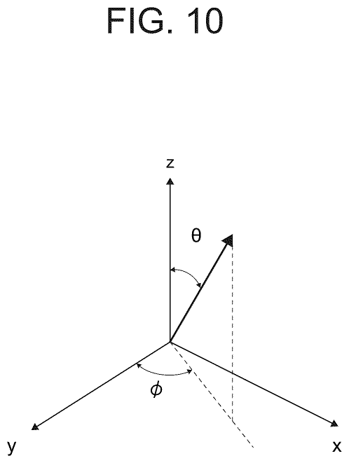

FIG. 10 illustrates an inclination of the cutting tool 110. An origin is located at a point on the rotation axis of the cutting tool 110 and a z-axis of the cutting tool is made to coincide with the straight line that is passes through the origin and parallel to the central axis of the surface 210. The central axis of the surface 210 corresponds to the optical axis of a microlens surface. An x-axis and a y-axis of the cutting tool are orthogonal to each other and are defined in a plane orthogonal to the z-axis of the cutting tool. How to determine the x-axis and the y-axis of the cutting tool will be described later. An angle (acute angle) formed by the z-axis of the cutting tool and the rotation axis of the cutting tool is represented by θ. An angle (acute angle) formed by the y-axis of the cutting tool and a plane containing the z-axis of the cutting tool and the rotation axis of the cutting tool is represented by ϕ.

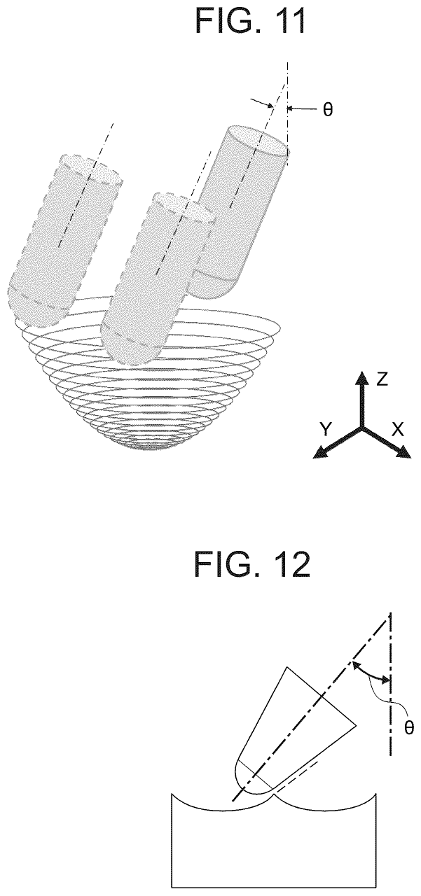

FIG. 11 shows a positional relationship between a cutting tool and a tool path when an angle (acute angle) formed by the z-axis of the cutting tool and the rotation axis of the cutting tool is θ. In the case of a conventional machining method described using FIG. 6, an angle (acute angle) formed by the z-axis of the cutting tool and the rotation axis of the cutting tool is 0.

FIG. 12 is a drawing used to describe how to determine a maximum value of an angle (acute angle) θ formed by the z-axis of the cutting tool and the rotation axis of the cutting tool. FIG. 12 shows a cross section containing the central axis of the cutting tool and the central axis of the surface 210. The maximum value of θ is determined such that a side of the cutting tool is not brought in contact with the surface 210.

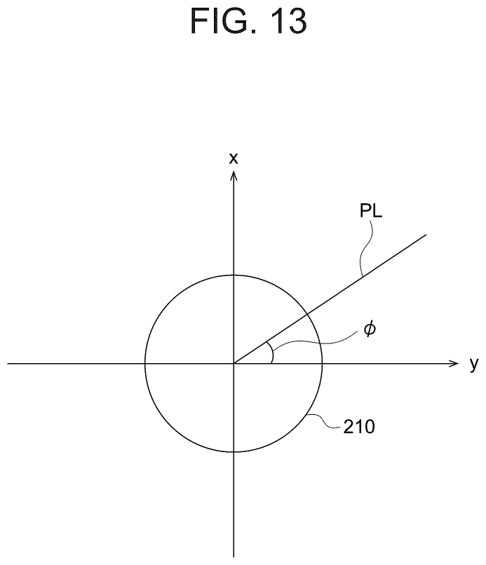

FIG. 13 illustrates an angle ϕ (acute angle) formed by the y-axis of the cutting tool and a plane containing the z-axis of the cutting tool and the rotation axis of the cutting tool. In FIG. 13 a z-axis of a surface 210 of the mold is defined so as to coincide with the central axis of the surface, the surface corresponding to a microlens surface. An x-axis and a y-axis of the surface, the x-axis and y-axis being orthogonal to each other, are defined in a plane orthogonal to the z-axis of the surface. X-axes of the surfaces of the mold corresponding to microlens surfaces are determined such that the axes are parallel to one another. Similarly, y-axes of the surfaces of the mold corresponding to microlens surfaces are determined such that the axes are parallel to one another and z-axes of the surfaces of the mold corresponding to microlens surfaces are determined such that the axes are parallel to one another. An x-axis of the cutting tool is determined to be parallel to the x-axis of the surface and a y-axis of the cutting tool is determined to be parallel to the y-axis of the surface. An angle ϕ corresponds to an angle around the central axis of a surface 210. In FIG. 13, an angle ϕ is measured counterclockwise from the y-axis. A plane that contains the z-axis of the surface and forms an angle ϕ with the surface that contains the y-axis and the z-axis of the surface is represented by PL. In the case of a conventional machining method described using FIG. 6, the angle ϕ of the cutting tool remains constant while machining of a surface corresponding to a lens surface is carried out.

When the machine shown in FIG. 1 is used for cutting, the angle θ corresponds to the angle represented by C and the angle ϕ corresponds to the angle represented by B. In the case of a conventional machining method, the angles represented by B and C are kept constant and the angle represented by C is determined such that the rotation axis of the cutting tool 110 in the vertical direction. In this case the angle θ is 0.

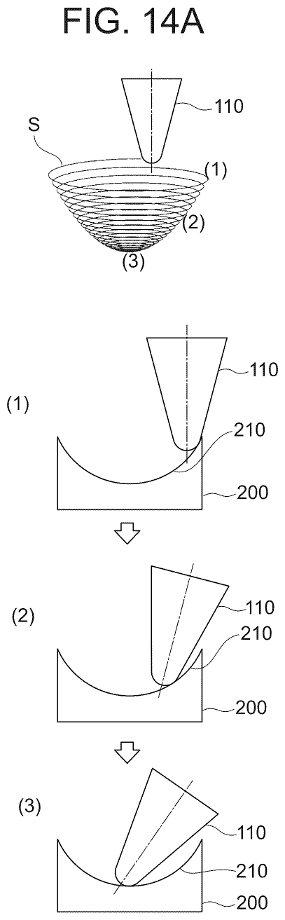

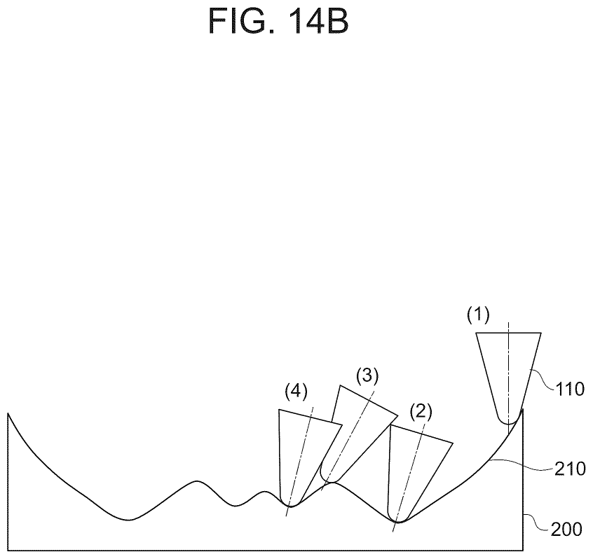

FIG. 14A is a drawing used to describe a machining method according to an embodiment of the present invention. In the machining method according to the present embodiment, when machining of a surface 210 of the mold, the surface corresponding to a lens surface, is carried out, the angle ϕ is kept constant and the angle θ is made to increase with decrease in distance between the cutting point and the central axis of the surface 210. Each of cross sections shown in FIG. 14A-(1), FIG. 14A-(2) and FIG. 14A-(3) corresponds to the plane PL described using FIG. 13. The angle θ is 0 when the periphery of the surface 200 is machined as shown in FIG. 14A-(1). The angle θ is made to increase with decrease in distance between the cutting point and the central axis of the surface 210 and the angle θ is made to reach a maximum value when the cutting point is at the position of the central axis of the surface 210 as shown in FIG. 14A-(3). The maximum value of the angle θ is 3 degrees or greater.

In a machining method according to the present embodiment, the angle represented by B is kept constant when machining of a surface is carried out. On the other hand, the angle represented by C is made to increase with decrease in distance between the cutting point and the central axis of the surface 210.

The angle θ should preferably be made to continuously and monotonously increase with decrease in distance between the cutting point and the central axis of the surface 210. A rate of change in angle θ is determined such that an working accuracy of positioning of each axis of the machine is equal to or less than a certain value. By way of example, the certain value is 10 nanometers.

FIG. 14B is a drawing used to describe a machining method according to another embodiment of the present invention. FIG. 14B shows a cross section containing the central axis of a surface 210. In the machining method according to the present embodiment, when machining of the surface 210 of the mold, the surface corresponding to a lens surface, is carried out, the angle ϕ is kept constant and the angle θ is made to change according to a shape of the surface 210. In 14B-(1) the angle θ is 0 and a side of the cutting tool is not in contact with the surface 210. In 14B-(2), 14B-(3) and 14B-(4), the angle θ is determined such that a side of the cutting tool is not brought in contact with the surface 210. A maximum value of the angle θ is 3 degrees or greater.

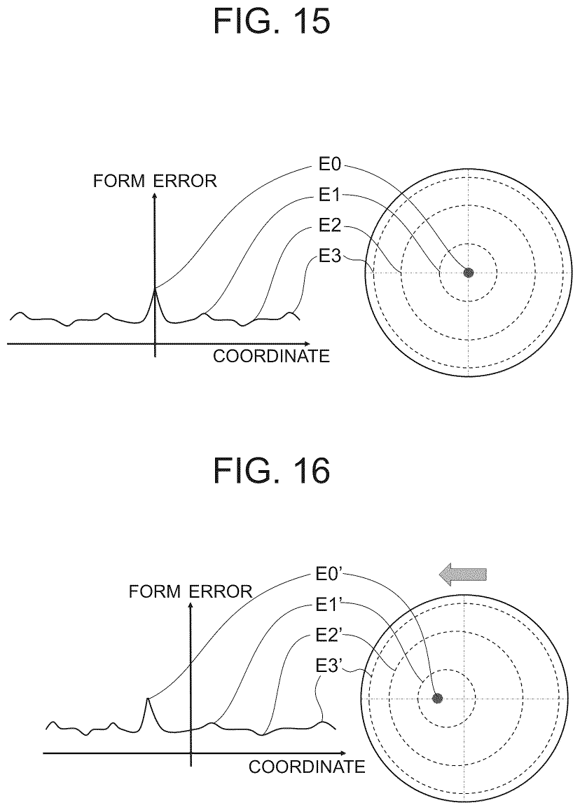

FIG. 15 is a diagram showing form error of a surface 210 generated in a conventional machining method in which the angle ϕ is kept constant and the angle θ is kept at 0. The drawing on the left side of FIG. 15 shows form error of the surface 210 in a cross section cut by the plane PL described using FIG. 13. The horizontal axis of the drawing on the left side indicates coordinate in the direction perpendicular to the central axis of the surface 210 and the vertical axis of the drawing on the left side indicates form error. The drawing on the right side of FIG. 15 is a plan view of the surface 210. When a position of a point P on the cutting blade of the cutting tool is represented by an angle (acute angle) formed by the rotation axis and the straight line connecting the point O and the point P and form error in shape of the cutting blade is prominent at positions represented by angles α0, α1, α2 and α3, prominent form error in shape of the surface 210 is generated at positions E0, E1, E2 and E3 that are cut respectively by the positions represented by angles α0, α1, α2 and α3 of the cutting blade. α0 is 0. In FIG. 15, E0 where a maximum value of form error appears is located around the central axis of the surface 210. The shape shown in FIG. 15 is symmetrical around the z-axis.

FIG. 16 is a diagram showing form error of a surface 210 generated in a machining method according to the present invention, in which the angle θ is made to increase with decrease in distance between the cutting point and the central axis of the surface 210. The drawing on the left side of FIG. 16 shows form error of the surface 210 in a cross section cut by the plane PL described using FIG. 14A. The horizontal axis of the drawing on the left side indicates coordinate in the direction perpendicular to the central axis of the surface 210 and the vertical axis of the drawing on the left side indicates form error. The drawing on the right side of FIG. 15 is a plan view of the surface 210. When a position of a point P on the cutting blade of the cutting tool is represented by an angle (acute angle) formed by the rotation axis and the straight line connecting the point O and the point P and form error in shape of the cutting blade is prominent at positions represented by angles α0, α1, α2 and α3, prominent form error of the surface 210 is generated at positions E0′, E1′, E2′ and E3′ that are cut respectively by the positions represented by angles α0, α1, α2 and α3 of the cutting blade. α0 is 0. In FIG. 16, E0′ where a maximum value of form error appears is located on the left side of the central axis of the surface 210.

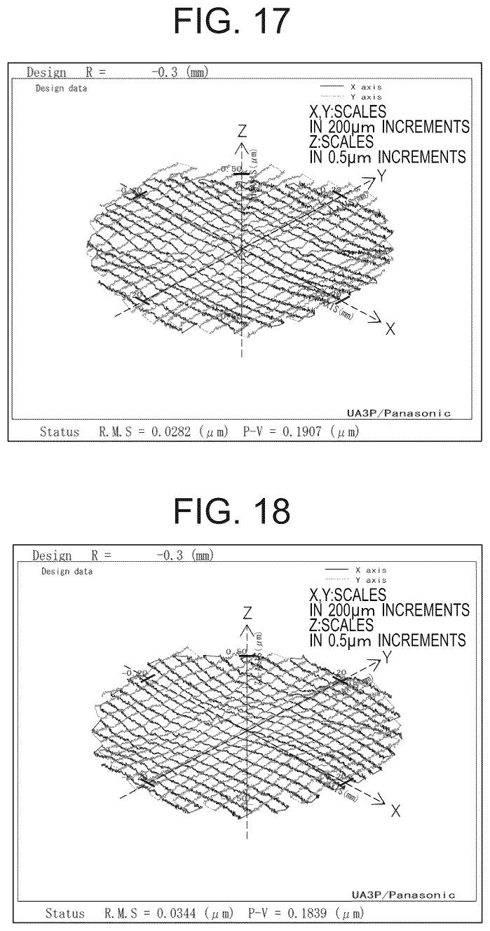

FIG. 17 shows actual form error generated on a surface 210 that has been cut according to a machining method described using FIG. 15. In FIG. 17 and FIG. 18, a z-axis is made to coincide with the central axis of a surface 210, the origin is located at the point of intersection of the central axis with the surface 210 and an x-axis and a y-axis are defined such that the x-axis and the y-axis are orthogonal to each other. The x-axis and the y-axis are calibrated in 200 micrometers and the z-axis is calibrated in 0.5 micrometers. The cross section shown in the drawing on the left side of FIG. 15 corresponds to the x-z plane in FIG. 17. In FIG. 17, a maximum value of form error appears around the origin.

FIG. 18 shows actual form error generated on a surface 210 that has been cut according to a machining method described using FIG. 16. The plane shown in the drawing on the left side of FIG. 16 corresponds to the x-z plane in FIG. 18, that is, the plane PL described using FIG. 13. In FIG. 18, a maximum value of form error appears at a point on the x-axis, x coordinate of which is negative. In the case shown in FIG. 18, the plane PL is a plane containing the z-axis and the x-axis of the surface.

In this way, when machining is carried out according to the machining method described using FIG. 16, a position where form error in shape of the surface is prominent can be moved in the plane PL.

As described using FIG. 12, the cutting tool tends to be brought in contact with a surface 210 of the mold at the periphery of the surface 210, where distance from the central axis of the surface 210 is relatively great. Accordingly, if the angle θ is set at 0, for example, when an area at the periphery of the surface 210 of the mold is cut and the angle θ is made to increase with decrease in distance between the cutting point and the central axis of the surface 210, the contact described above can be avoided.

In another embodiment, machining can be carried out such that the angle θ is made to increase with decrease in distance between the cutting point and the central axis when the distance is greater than a predetermined value and the angle θ is kept constant independently of the distance when the distance is equal to or smaller than the predetermined value.

In general, it is not necessary that the angle θ is made to vary during the cutting process of the surfaces of a mold corresponding to all the surfaces of a microlens. During the cutting process of one or plural surfaces of the mold, the angle θ can be kept constant. A maximum value of angle θ can be made to vary from one surface of the mold to another. It is preferable that a maximum value of angle θ is set at 3 degrees or greater in 50 percent or more of all the surfaces of the mold such that positions at which form error is prominent sufficiently vary from one surface of the mold to another.

It will be described below how the form error in surfaces of a mold has an influence upon optical performance of a microlens array that is produced using the mold. Optical simulation was carried out for each case in which a flat surface is illuminated with a parallel light beam that is perpendicular to the flat surface and has passed through the microlens array. The microlens array is provided with spherical microlenses of the radius of 0.3 millimeters.

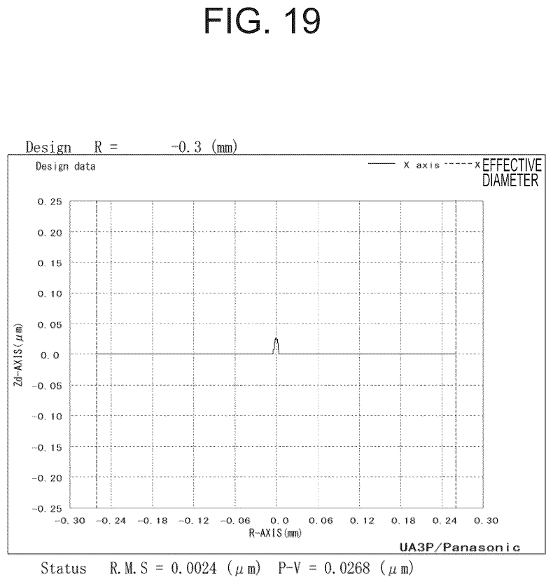

FIG. 19 shows form error of a surface 210 of a mold in a cross section cut by an x-z plane. The horizontal axis of FIG. 19 indicates position in the x-axis direction. The unit of length is millimeter. The vertical axis of FIG. 19 indicates form error. The unit of length is micrometer. FIG. 19 shows form error of a mold that has been produced by the machining method described using FIG. 15. For simplicity it was assumed that form error appears around the central axis of the surface 210 alone.

As described above, when machining is carried out according to the machining method described using FIG. 16, a position where form error of the surface is prominent can be moved in the plane PL. In the case that the angle θ is made to increase from 0 degree to 15 degrees with decrease in distance from the central axis, as the cutting point approaches the central axis from the periphery of the surface 210, the surface 210 is cut by the position of the angle α0 of the cutting blade when the angle θ is 11 degrees. The position on the surface 200 that is cut by the position of the angle θ of the cutting blade is the position of −0.06 millimeters on the horizontal axis of FIG. 19. Optical simulation was carried out on the assumption that form error identical with that shown in FIG. 19 appears at the position of −0.06 millimeters on the horizontal axis when a surface of a mold has been cut according to the machining method described using FIG. 16.

When for plural surfaces of a mold, the plural surfaces corresponding to plural microlenses, the angle ϕ of the plane PL is made to vary from one surface to another according to the machining method described using FIG. 16, positions at which a prominent form error appears on each surface can be moved in the plane PL differently determined by the angle ϕ of each surface.

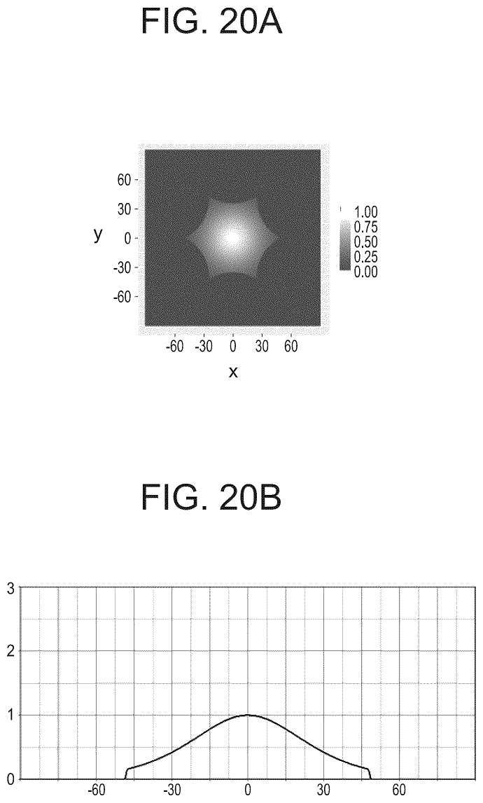

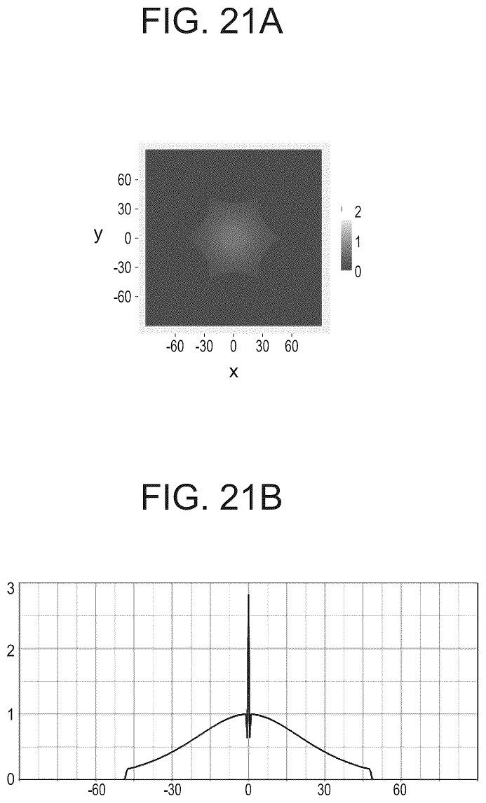

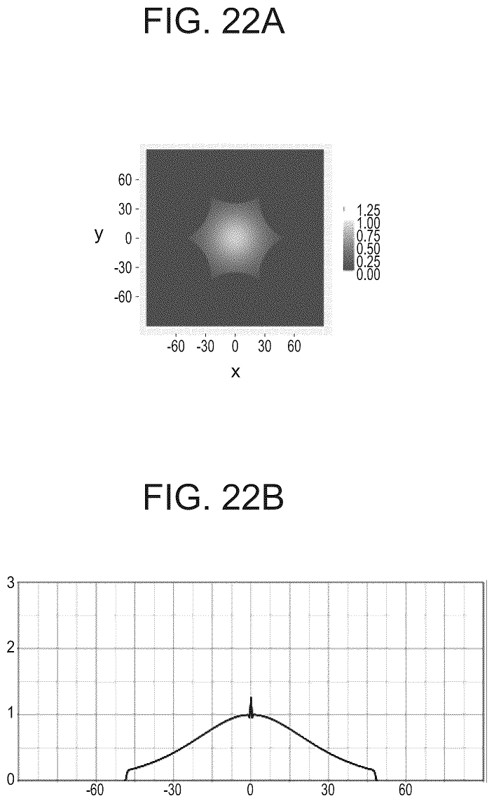

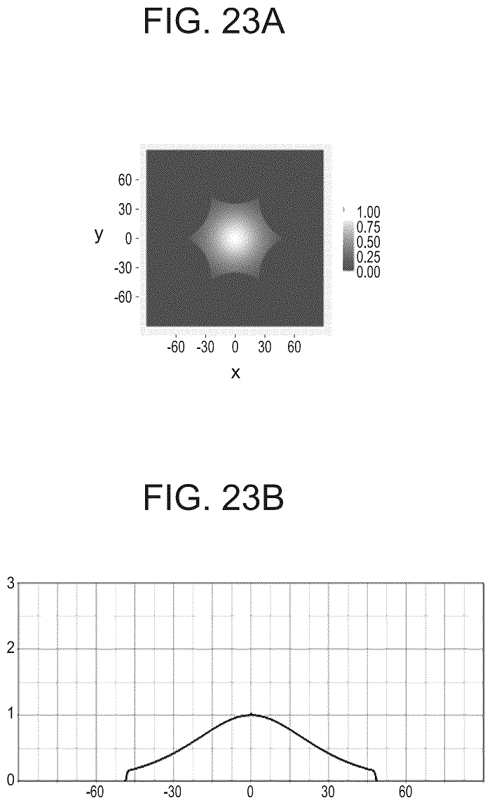

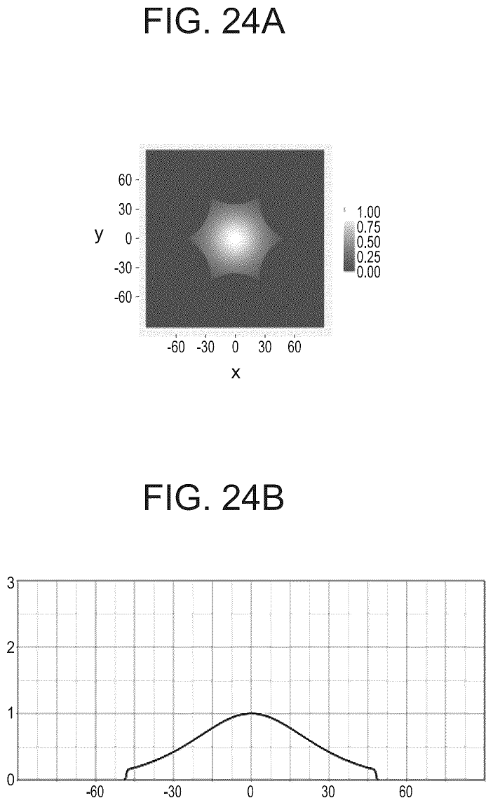

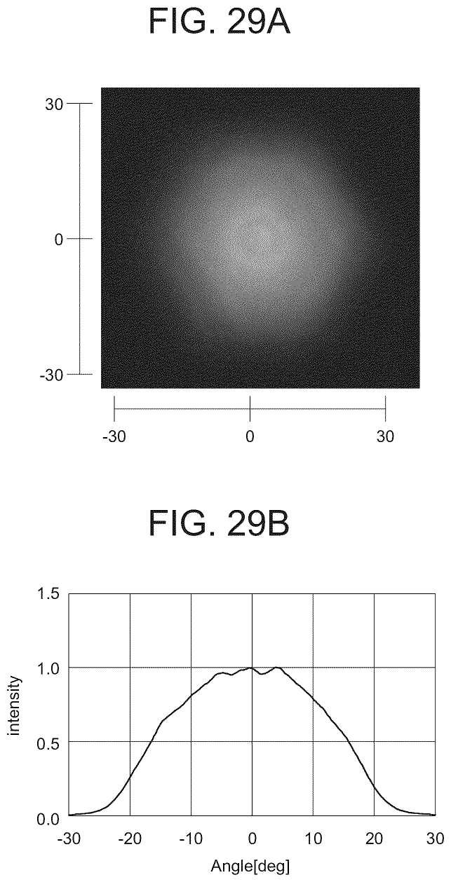

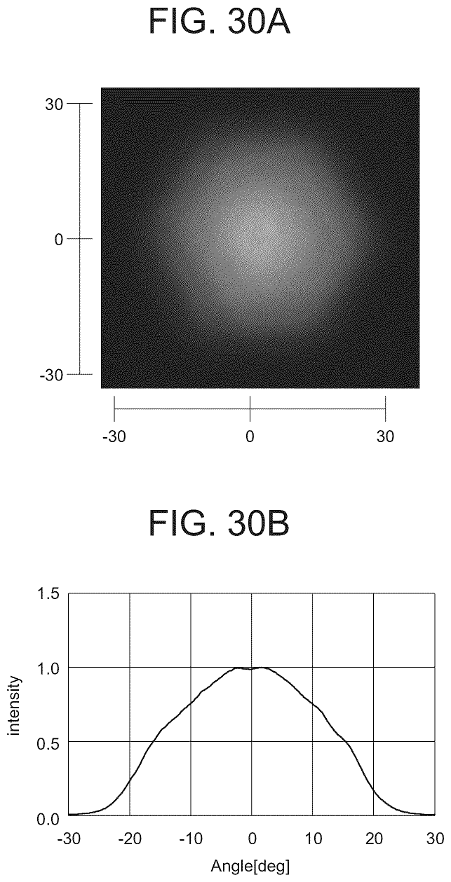

FIG. 20A shows an illuminance distribution on a flat surface illuminated through a microlens array produced using a mold without form error. The horizontal axis of FIG. 20A indicates angle that a straight line that is a projection on an x-z plane of a ray that has passed the microlens array and reaches the illuminated surface forms with a z-axis. The vertical axis of FIG. 20A indicates angle that a straight line that is a projection on a y-z plane of a ray that has passed the microlens array and reaches the illuminated surface forms with the z-axis. The z-axis is made to coincide with the straight line that passes the center of the microlens array and is parallel to the center axes of the microlenses and the x-axis and the y-axis are defined as straight lines that are orthogonal to each other in a plane perpendicular to the z-axis. Angle indicated by the horizontal axis and angle indicated by the vertical axis of each of FIG. 21A, FIG. 22A, FIG. 23A, FIG. 24A, FIG. 29A and FIG. 30A are defined in the same way as described concerning FIG. 20A.

FIG. 20B shows a cross section cut by an x-z plane of the illuminance distribution shown in 20A. The horizontal axis of FIG. 20B indicates angle that a straight line that is a projection on the x-z plane of a ray that has passed the microlens array and reaches the illuminated surface forms with the z-axis. The vertical axis of FIG. 20B indicates relative values of illuminance. Angle indicated by the horizontal axis of each of FIG. 21B, FIG. 22B, FIG. 23B, FIG. 24B, FIG. 29B and FIG. 30B is defined in the same way as described concerning FIG. 20B. The vertical axis of each of FIG. 21B, FIG. 22B, FIG. 23B, FIG. 24B, FIG. 29B and FIG. 30B indicates relative values of illuminance.

FIG. 21A shows an illuminance distribution on a flat surface illuminated through a microlens array produced using a mold with the form error shown in FIG. 19.

FIG. 21B shows a cross section cut by an x-z plane of the illuminance distribution shown in 21A. As shown in FIG. 21B, there exists a great variance in illuminance around x=0.

FIG. 22A shows an example of an averaged illuminance distribution. The averaged illuminance distribution of FIG. 22A was obtained as below. First, an illuminance distribution on a flat surface illuminated through a microlens produced using a mold produced by a method in which the angle ϕ is set at each of 360/7 degrees, (360×2)/7 degrees, (360×3)/7 degrees, . . . and 360 degrees and the angle θ is made to increase from 0 to 15 degrees, was obtained by optical simulation. Then, the obtained illuminance distributions were averaged to obtain the illuminance distribution of FIG. 22A.

FIG. 22B shows a cross section cut by an x-z plane of the illuminance distribution shown in 22A.

In the averaged illuminance distribution obtained from illuminance distributions, each of which is obtained with a microlens produced using a mold having a surface that is cut by a cutting process during which the angle ϕ is set to one of the plural values, a variance in illuminance around x=0 is smaller than that shown in FIG. 21A and FIG. 21B.

FIG. 23A shows another example of an averaged illuminance distribution. The averaged illuminance distribution of FIG. 23A was obtained as below. First, an illuminance distribution on a flat surface illuminated through a microlens produced using a mold produced by a method in which the angle ϕ is set at each of 360/61 degrees, (360×2)/61 degrees, (360×3)/61 degrees, . . . and 360 degrees and the angle θ is made to increase from 0 to 15 degrees, was obtained by optical simulation. Then, the obtained illuminance distributions were averaged to obtain the illuminance distribution of FIG. 23A.

FIG. 23B shows a cross section cut by an x-z plane of the illuminance distribution shown in 23A.

FIG. 24A shows another example of an averaged illuminance distribution. The averaged illuminance distribution of FIG. 24A was obtained as below. First, an illuminance distribution on a flat surface illuminated through a microlens produced using a mold produced by a method in which the angle ϕ is set at each of 360/127 degrees, (360×2)/127 degrees, (360×3)/127 degrees, . . . and 360 degrees and the angle θ is made to increase from 0 to 15 degrees, was obtained by optical simulation. Then, the obtained illuminance distributions were averaged to obtain the illuminance distribution of FIG. 24A.

FIG. 24B shows a cross section cut by an x-z plane of the illuminance distribution shown in 24A.

When FIG. 21B-FIG. 24B are observed, it is clear that the greater the number of the values of the angle ϕ, the smaller a variance in illuminance around x=0 is.

Variance of the angle ϕ will be described below. For simplicity the number of microlenses is assumed to be 6. When the angle ϕ is 0 for surfaces 210 corresponding to all the microlenses, variance of the angle ϕ is 0. When the microlenses are divided into three groups, each of which contains two microlenses, and in each group, values of the angle ϕ for surfaces 210 corresponding to the two microlenses are 0 and 180 degrees, variance is 9720. In this case, the same value of the angle ϕ is used for three surfaces. When the microlenses are divided into two groups, each of which contains three microlenses, and in each group, values of the angle ϕ for surfaces 210 corresponding to the three microlenses are 0, 120 degrees and 240 degrees, variance is 11520. In this case, the same value of the angle ϕ is used for two surfaces. When the microlenses are made to belong to one group and values of the angle ϕ for surfaces 210 corresponding to the six microlenses are 0, 60 degrees, 120 degrees, 180 degrees, 240 degrees and 300 degrees, variance is 12600. In this case, different values of the angle ϕ are used for all the surfaces. In each group, the values of the angle ϕ are set at regular intervals between 0 and 360 degrees. The smaller the number of surfaces for which the same value of the angle ϕ is used, the greater variance of the angle ϕ is.

In general, in a microlens array having a certain number of microlenses, the greater a variance of the angle ϕ for surfaces 210 corresponding to the microlens surfaces, the smaller a variance in illuminance around x=0 is.

In order to determine values of the angle ϕ for plural surfaces such that a great value of variance is obtained, values of the angle ϕ can be uniformly distributed or set at regular intervals between 0 and 360 degrees as described above. Alternatively, the plural surfaces are divided into plural groups, and in each group, values of the angle ϕ for plural surfaces can be uniformly distributed or set at regular intervals between 0 and 360 degrees. In the case of a great number of surfaces, values of the angle ϕ for the surfaces can be determined using pseudorandom numbers.

Molds for a microlens array are produced such that values of the angle ϕ for the plural surfaces in each mold are changed so as to increase variance of the angle ϕ. By comparing illuminance distributions on a flat surface illuminated through microlens arrays produced using the molds thus produced with one another, an appropriate distribution of the angle ϕ for the plural surfaces in a mold can be determined.

Microlens arrays actually produced will be described below. Each microlens array includes 421 microlenses each of which has a spherical surface of radius of 0.1 millimeters.

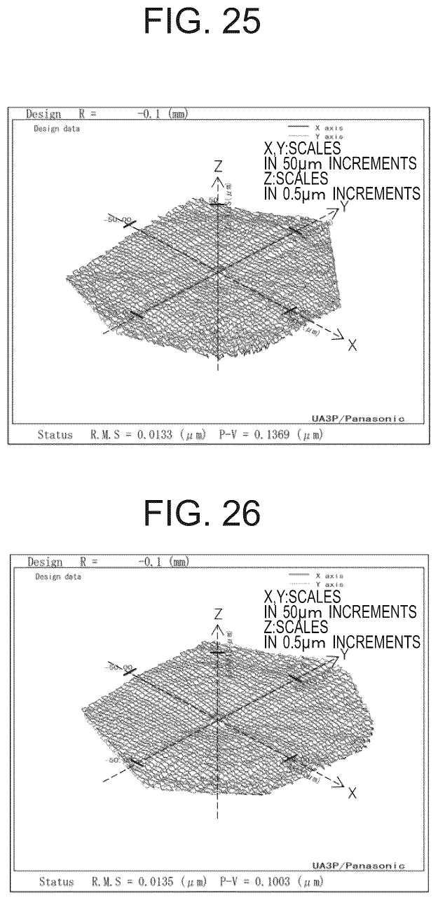

FIG. 25 shows an actual form error of a surface of a mold, the surface corresponding to a microlens surface, produced by the conventional machining method described using FIG. 15. In FIGS. 25-28, a z-axis is made to coincide with the central axis of a surface 210, the origin is located at a point of intersection of the central axis with the surface 210 and an x-axis and a y-axis orthogonal to each other are defined in a plane orthogonal to the z-axis.

FIG. 26 shows an actual form error of another surface of a mold, the surface corresponding to another microlens surface, produced by the conventional machining method described using FIG. 15.

According to FIG. 25 and FIG. 26, a maximum value of form error appears around the central axis in both cases.

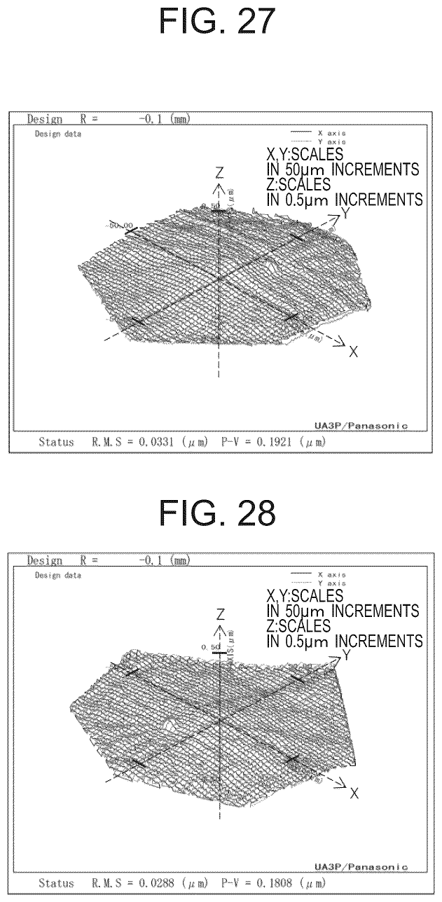

FIG. 27 shows an actual form error of a surface of a mold, the surface corresponding to a microlens surface, produced by the machining method according to the present invention, the method having been described using FIG. 16.

FIG. 28 shows an actual form error of another surface of a mold, the surface corresponding to another microlens surface, produced by the machining method according to the present invention, the method having been described using FIG. 16.

According to FIG. 27 and FIG. 28, a position at which a maximum value of form error appears in FIG. 27 and a position at which a maximum value of form error appears in FIG. 28 are different from each other. More specifically, in FIG. 27 the maximum value of form error appears in the quadrant where values of x-coordinate and values of y-coordinate are positive and in FIG. 28 the maximum value of form error appears in the quadrant where values of x-coordinate and values of y-coordinate are negative. A position at which a maximum value of form error appears is determined by a value of the angle ϕ.

In the present example, values of the angle ϕ for 421 surfaces of the mold corresponding to 421 microlens surfaces are determined using pseudorandom numbers.

FIG. 29A shows an illuminance distribution on a flat surface illuminated through a microlens array produced by the machining method described using FIG. 15.

FIG. 29B shows a cross section cut by an x-z plane of the illuminance distribution shown in 29A.

When machining is carried out through the machining method described using FIG. 15, a maximum value of form error appears around the central axis in each of the plural surfaces of the mold as shown in FIG. 25 and FIG. 26. Accordingly, in FIG. 29A and FIG. 29B, an annular shape due to variance in illuminance appears around the central axis.

FIG. 30A shows an illuminance distribution on a flat surface illuminated through a microlens array produced by the machining method described using FIG. 16.

FIG. 30B shows a cross section cut by an x-z plane of the illuminance distribution shown in 30A.

When machining is carried out through the machining method described using FIG. 16, a position where a maximum value of form error appears can be made to vary form one to another of plural surfaces of the mold as shown in FIG. 27 and FIG. 28. Accordingly, in FIG. 30A and FIG. 30B, an annular shape due to variance in illuminance does not appear around the central axis.

What is claimed is:

1. A method of machining a mold for a microlens array provided with plural microlenses that have optical axes in the same direction and that are identically shaped using a cutting tool provided with a cutting blade that rotates around a rotation axis,
wherein for a surface of the mold corresponding to a microlens surface, an xyz orthogonal coordinate system is defined such that a z-axis is in the direction of the central axis of the surface of the mold, the central axis corresponding to the optical axis of the microlens, an angle θ is defined as an angle formed by the rotation axis of the cutting tool and a straight line passing through a point on the rotation axis and parallel to the z-axis, an angle φ is defined as an angle around the straight line of a plane containing the rotation axis of the cutting tool and the straight line and xyz orthogonal coordinate systems of plural surfaces of the mold corresponding to plural microlens surfaces are defined such that x-axes of the surfaces are parallel to one another and y-axes of the surfaces are parallel to one another,
wherein in machining of a surface of the mold, the angle φ is kept constant and in machining of at least one surface of the mold, the angle θ is changed and
wherein in machining of the plural surfaces of the mold, values of the angle φ for the plural surfaces of the mold are distributed so as to make variance of the values of the angle φ greater than a predetermined value such that variance in illuminance on a surface illuminated using a microlens array produced using the mold can be sufficiently reduced.

2. The method of machining a mold for a microlens array according to claim 1, wherein a maximum value of the angle θ is determined for each surface of the mold.

3. The method of machining a mold for a microlens array according to claim 1, wherein in surfaces of the mold corresponding to 50 percent or more of all the microlens surfaces, a maximum value of the angle θ is 3 degrees or greater.

4. The method of machining a mold for a microlens array according to claim 1, wherein in machining of a surface of the mold, the angle θ is adjusted in an area where a distance between a cutting point of the cutting tool and the central axis of the surface is greater than a predetermined value and the angle θ is kept at a constant value in an area where a distance between the cutting point of the cutting tool and the central axis of the surface is equal to or smaller than the predetermined value.

5. The method of machining a mold for a microlens array according to claim 1, wherein in machining of a surface of the mold, when the angle θ is changed, a value of angular acceleration of the angle θ is determined such that an working accuracy of positioning of the cutting tool in all moving directions is equal to or less than a predetermined value.

6. The method of machining a mold for a microlens array according to claim 1, wherein in machining of a surface of the mold, a tool path is spiral around the central axis of the surface.

7. The method of machining a mold for a microlens array according to claim 1, wherein in machining of the plural surfaces of the mold corresponding to the plural microlens surfaces, the plural surfaces of the mold are divided into one or plural groups and in each group values of the angle q are uniformly distributed or set at regular intervals between 0 and 360 degrees.

8. The method of machining a mold for a microlens array according to claim 1, wherein a 5-axis machine is used for machining, each x-axis, each y-axis and each z-axis are made to correspond to three linear-motion axes of the 5-axis machine and the angle θ and the angle φ are made to correspond to angles around two rotation axes of the 5-axis machine.

9. The method of machining a mold for a microlens array according to claim 1, wherein in machining of a surface of the mold, the angle θ is made to increase with decrease in distance between a cutting point of the cutting tool and the central axis of the surface.

10. The method of machining a mold for a microlens array according to claim 1, wherein in machining of a surface of the mold, the angle θ is changed according to a shape of the surface such that a side of the cutting tool is not brought in contact with the surface.

11. A method of producing a microlens array using a mold that has been machined according to the method of machining a mold claimed in claim 1.
